(19) United States
(12) Patent Application Publication
(10) Pub. No.: US 2011/0305606 A1
(43) Pub. Date: Dec. 15, 2011

(54) Apparatus and Method for Vaporizing Natural Substances

(76) Inventor: Thomas Kilby, Carbondale, CO (US)

(21) Appl. No.: 13/158,206

(22) Filed: Jun. 10, 2011

Related U.S. Application Data
(60) Provisional application No. 61/353,532, filed on Jun. 10, 2010.

(51) Int. Cl. B01J 7/00; H04W 4/00; G01N 25/00

(52) U.S. Cl. 422/305; 73/25.01; 455/557

(57) ABSTRACT

A vaporizer unit having two air streams that converge to one. The vaporizer measures temperature differentials between a heating chamber and a chamber outlet and based on such measurements indicates to a user whether or not compound is present in an air stream, Additionally, the vaporizer is connectible to a smartphone. A connected smarthphone controls the functions of the vaporizer and receives information about conditions of the same.

### RELATED APPLICATIONS

This application claims the benefit of U.S. Provisional Application Ser. No. 61/353,532, filed on Jun. 10, 2010—the contents of which are incorporated by reference herein.

### FIELD OF INVENTION

The invention relates to the field of vaporizers, more specifically a vaporizer for natural plant compounds and which is controllable a microprocessor power to regulate temperature and measure temperature atmospheric pressure differentials; and interface with a computing device,

### BACKGROUND OF THE INVENTION

Smoking is a widely practiced recreational or therapeutic activity. Typically, smoking entails combusting a natural plant compounds in order to release a compound's active ingredients and then inhaling those compounds in the resultant smoke. Common forms of smoking include cigarettes, cigars, & pipes.

One of many drawbacks associated with combustion is that it induces substantial denaturing of the compound being burned. When a compound is “denatured”, for example, when catalyzed by a flame, its chemical make-up changes. New compounds are then created that were not originally within the plant itself.

In the process of vaporization or volatilization, on the other hand, active elements of a compound are released without any combustion. Vaporization produces little or no smoke, little or no carcinogens, tar, or other known toxic elements. This reduces many of the harmful byproducts of combustion.

The current invention is directed to a novel vaporizing apparatus, which uses heated air to release the vital elements; without combustion. A microprocessor maintains precise temperature levels and measures atmospheric pressure to precisely deliver heat to a compound in the compound chamber. A unique airflow system delivers air to a heating chamber and transports it through a diffuser to evenly distribute the heated air over a compound in the compound vessel. Additionally, the invention's microprocessor uses atmospheric pressure to activate the heating system on inhalation, determines if the remaining life a compound in the compound vessel has expired and performs diagnostics.

The inventive vaporizer draws ambient air into a heating chamber. Once heated, the air travels through a diffuser and into a chamber vessel containing a compound to be vaporized, this releasing the compound's active elements. Air containing the active elements of the compound is then mixed with additional ambient air and inhaled by the user.

In addition, the inventive vaporizer is provided with a port (or similar wired or wireless) linkage for communicating with a computer device. When the vaporizer is connected, a two-way communication link is formed and digital data can be shared, including the invention's diagnostic data, digital images and files, master control software, etc.

### BRIEF DESCRIPTION OF THE DRAWINGS

FIG. 1 shows a front view of the inside of a vaporizer unit according to an embodiment of the invention.

FIG. 2 shows side cross-sectional view taken through the length of a vaporizer unit according to an embodiment of the invention.

FIG. 3 shows a rear view of the inside of a vaporizer according to an embodiment of the invention.

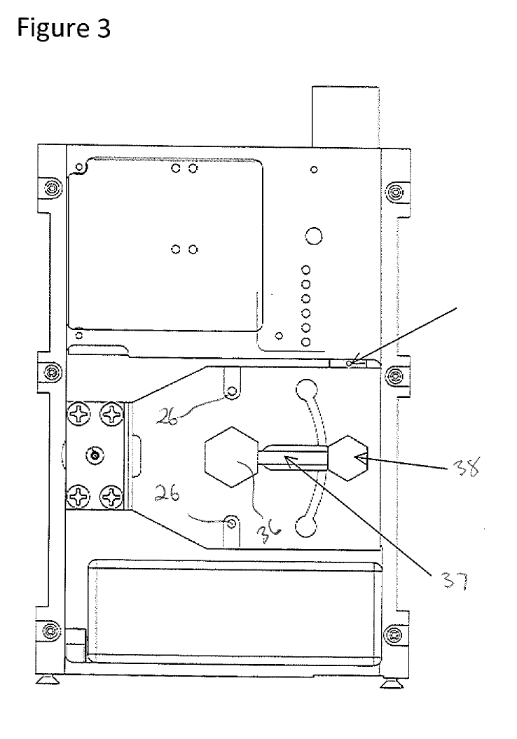

FIG. 4 shows a cross-sectional view taken through the width of a vaporizer according to an embodiment of the invention.

FIG. 5 shows a front view of vaporizer unit having a housing and a vessel door according to an embodiment of the invention.

### DETAILED DESCRIPTION OF THE INVENTION

The following is a detailed description of the preferred embodiments of the invention, reference being made to the drawings in which the same reference numerals identify the same elements of the structure in each of the several figures. It should be noted that these drawings are merely exemplary in nature and in no way serve to limit the scope of the invention, which is defined by the claims appearing herein below.

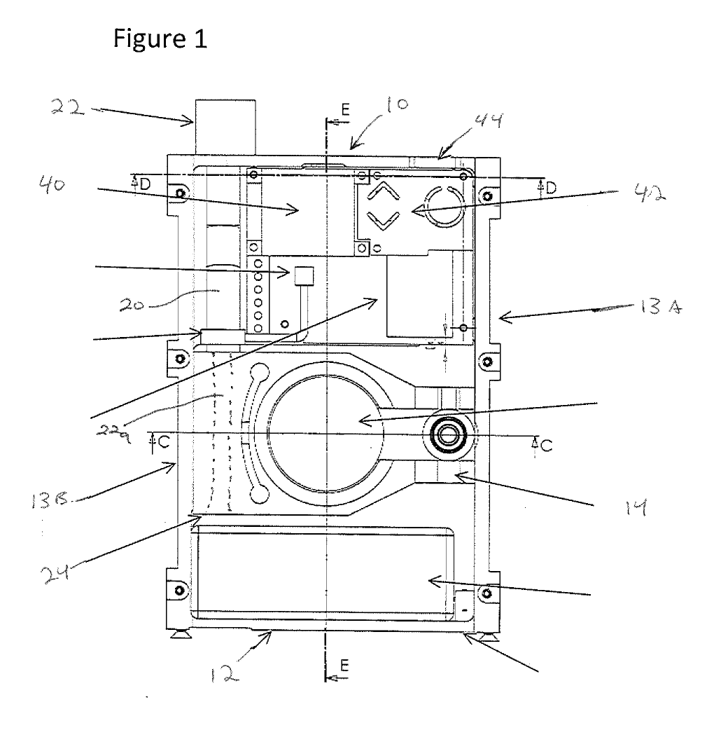

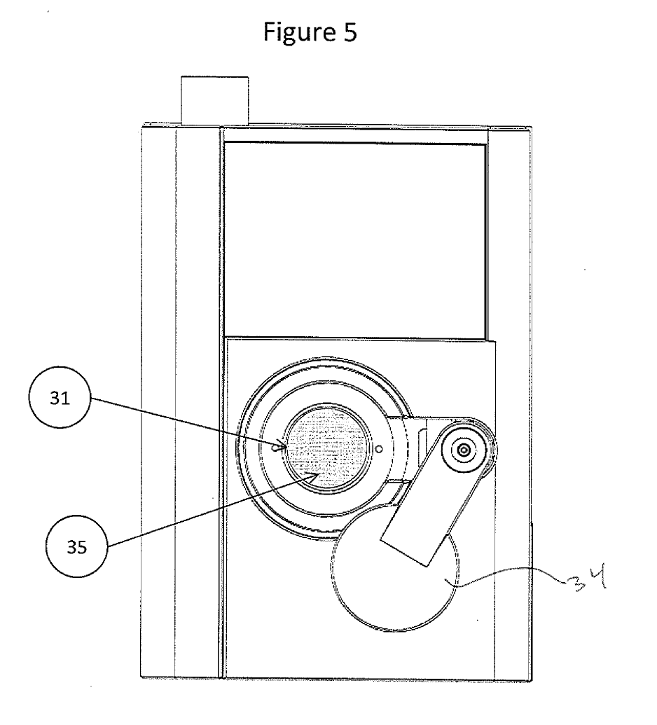

FIG. 1 shows a schematic view of the inner components of a vaporizer unit. Shown in FIG. 1 are top 10, bottom 12, front 14 and side Surfaces 13a, 13b. The housing walls are omitted in FIG. 1 for the purposes of showing the mechanical workings within the unit. As shown, in FIG. 5, the unit comprises outer walls, which form the housing for the unit.

As shown in FIG. 1, a primary draw tube 20 spans a portion of the length of the device. Tube 20 terminates in a mouthpiece 22 on the top surface 10 of the unit. Tube 20 extends downwardly from the mouthpiece 22 and has an inlet or opening to allow for the intake of air. In FIG. 1, tube 20 is shown continuing as a channel 22a (shown in broken lines) through a solid surface, which forms part of the compound vessel housing. As shown, tube 20 terminates at inlet 24.

The primary airflow draw tube 20 is the direct interface between a user and the compound to be dispensed. Air and active ingredient is delivered to a user when he/she inhales on the mouthpiece 22 attached to the primary airflow draw tube 20.

When the user draws on the mouthpiece 22, two separate inlets pull air through the device in two routs that merge into one. The primary draw tube inlet 20 draws ambient air directly to the user. In addition a secondary draw inlets draw air to the heating chamber ring.

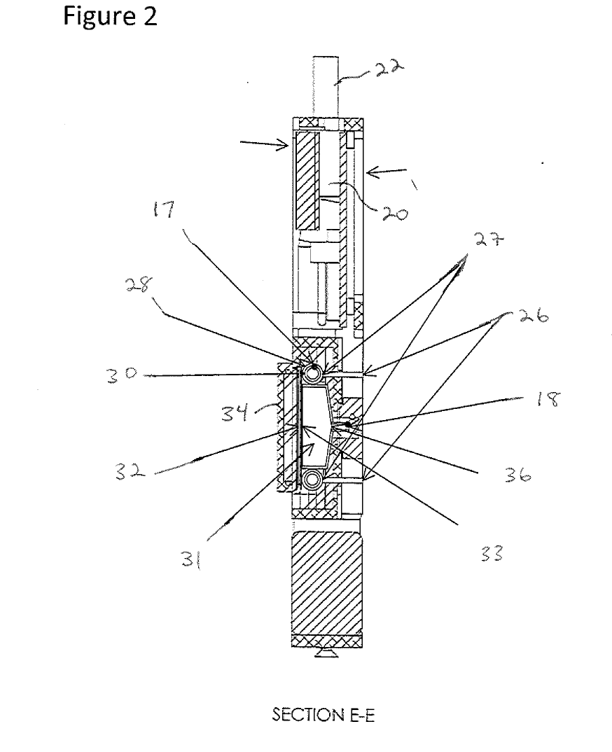

FIG. 2 shows a side cross-section (Section E-E as identified in FIG. 1) through the length of the unit. A compound vessel 31 is shown, which is an internal chamber for holding compound. Heated air flowing through a diffuser plate 33 heats the compound stored within the chamber and vaporizes the same. Air containing compound is then directed out of the chamber and eventually into primary tube 20 where compound-containing air mixes with ambient air.

In order for air to be introduced into the heating chamber 28, two secondary inlets 26 open to the rear surface of the unit. Air entering inlets 26 are directed by way of inlets 27 into a heating chamber ring 28. The heating chamber ring 28 contains heating coils or other heating elements 30—all of which are known to one of ordinary skill in the art. Air entering the heating chamber ring 28 is heated as it passes over the heating elements 30 to a temperature that is sufficient to release active ingredient from a compound when coming into contact therewith. Heated air then rises in a heated air duct ring around the compound vessel outer walls of a diffuser chamber 32 which is formed in the vessel door 34. The heating of the compound vessel outer walls subsequently contributes to the efficient vaporization in the compound vessel.

The diffuser chamber 32 delivers the heated air through the compound vessel door 34, evenly distributing heat through a distinct pattern of holes in a diffuser faceplate 33 above the compound in the compound vessel 31. When the heated air interacts with the compound—its active ingredient is released. The heated air now containing the vaporized active compound exits the compound vessel 31 through a catch screen 35 and eventually it is metered into the primary ambient air stream at a calibrated rate.

More specifically, air containing vaporized active compound exits the compound vessel 31 through outlet 36. Air exiting through outlet 36 is directed by way of a channel 37 to an orifice 38, which directs air containing compound into primary draw tube 20.

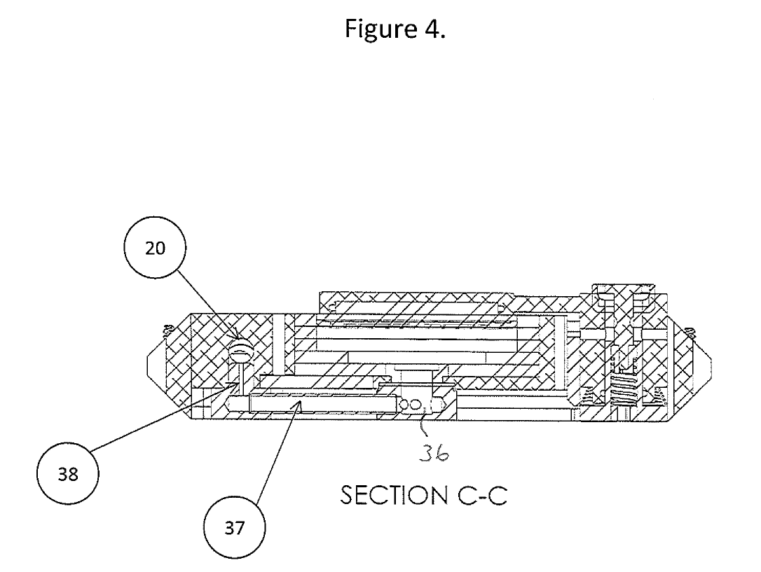

Referring to FIG. 4, which shows a cross-sectional view of through the middle of the unit (plane C-C as identified in FIG. 1), compound vessel outlet 36 is shown being contiguous with channel 37. Channel 37 terminates in orifice 38. Orifice 38 delivers compound-containing air into tube 20.

In a preferred embodiment of the invention, a mixture adjustment device is provided for controlling the metered calibration rate of the secondary stream mixture with the primary stream. This calibrated orifice is adjustable and controlled manually or by the invention's microprocessor. To that end, a mixture adjustment control mechanism such as an adjustable nozzle or such similar gas flow regulator is provided at secondary air stream outlet entering the primary air stream. Such adjustment of airflow could also be one controlling factor in the rate at which compound in vaporized.

Since vaporization produces little or no smoke, it is difficult for a user to determine if the active ingredient released by a compound has expired. An embodiment of the invention addresses this by providing an indicator as to a presence or absence of active ingredient within the secondary air stream.

Heated air in heating chamber 28 will lose some heat as it flows through the compound vessel 31 and finally exits at compound vessel outlet 36. Such ordinary heat loss occurs even when there is no compound present in the chamber. As such, there can be a measured temperature differential between the air in the heating chamber and the air exiting the compound chamber. However, when compound is present in the compound chamber and heated air is utilized to vaporize compound—more heat is lost in the process. Because heat is absorbed in the process of vaporizing compound—there is more heat loss in the presence of compound and hence a greater temperature differential between the air temperatures as measured in the heating chamber and that leaving the compound chamber.

The current invention determines whether or not active ingredient is present in an air stream based on calculated temperature differentials. A first temperature differential between heated air in the heating chamber and air exiting the compound vessel is calculated with no compound. The temperature differential determined for heat loss where no compound is present is used as a “standard” differential. If a temperature differential is great than the “standard” that indicates that additional heat is being absorbed by the vaporization process and that there is therefore active ingredient in the air stream.

Such temperature differentials are determined by way of at least two different thermocouples. A first thermocouple (TC1) 17 is situated in (or in thermal communication with) the heating chamber and a second thermocouple (TC2) 18 is situated near or in (in thermal communication with) the compound outlet 36. TC1 17 measures the temperature of the secondary air stream of the air being heated in the heating chamber ring 28. After the heated air passes through the diffuser chamber 32 and into the compound vessel 31 containing a compound to be vaporized, TC2 18 measures the temperature of the mixture of heated air and the vaporized compound at the compound vessel outlet 36.

Data on temperature differential trends from TC1 17, measuring air temperature in the heating chamber ring 28 and TC2 18, measuring the temperature of the mixture of heated air and the vaporized active ingredient at the compound chamber outlet 36 provides an indication of product expiration. As a compound's active ingredient begins to decay through vaporization, the temperature differentials change significantly between TC1 17 and TC2 18 when comparing when an active ingredient is present with when there is little or no active ingredients in the secondary airflow stream. This indicates the expiration of the active ingredient in a compound.

In a preferred embodiment, an alert on the invention's graphic user interface or GUI 42 is triggered when such temperature differential exists—thereby notifying a user whether or not that he/she is drawing active ingredient from the compound being vaporized.

In a preferred embodiment, a the system only triggers an alert when a temperature differential between TC1 17 and TC2 18 is a minimum number of degrees greater than the “standard” (“greater than standard” refers to the fact that there is greater spread between TC1 and TC2 because TC2 measures a lower temperature than what was measured for the standard). A minimum number may be for example three, two or even one degree. For example, if “three” is the selected minimum—then an alert will be triggered only when the differential between TC1 and TC2 is more than three degrees different than the standard—or in other words, three degrees were lost in the process of vaporization and hence TC2 measures a temperature that is three degrees lower than was measured in the standard.

In addition, (referring to FIG. 1) the inventive vaporizer is provided with a graphic user interface or GUI 40 and non-contact buttons 42 that allow the user to control the operations of the unit. The GUI 40 displays graphics indicating battery power, set point temperature, and a sequential count of the number of draws, draw strength, product expiration indicator, error codes and diagnostics.

In addition, the inventive vaporizer is provided with a USB port (or similar wired or wireless) 44 linkage for two way communication with a computer device or the Internet via special software. When the vaporizer is connected to a computer via the USB Port 44, digital capabilities are enhanced including file sharing, software updates, downloadable digital images and data to the GUI 40.

The invention can also be operated by a computer device smart phone or tablet independently when connected to a computer via USB port 44, including the typical operational functions such as On/Off, changing temp settings, reviewing operational archived data, etc.

In a preferred embodiment, functions of the vaporizer device are controllable through the use of an electronic device (e.g. smart phone) having specialized software. When the vaporizer is connected with a smart phone, by wired or wireless technologies, the operational capability of the vaporizer is enhanced by utilizing the additional processing power, user interface and web capabilities of the smart phone. When the vaporizer is connected, the user will have enhanced control of all functions of the vaporizer using the touch screen (or by computer screen and keypad/mouse). This includes turning the device on and off, changing vaporizer compound temperature settings, receiving and responding to device alerts and faults, collecting and reviewing operational history, accessing vaporizer operations, help features resident in the electronic device and over the internet, and connecting in real-time with customer service and technical support. The smart phone will display various controls, which when manipulated by a user will actually control any of various settings on the device. For example, a smart phone may display a control for temperature settings. By adjusting such setting on the smart phone, the temperature of the unit is correspondingly adjusted.

Importantly, communication between the device and a smart phone is two-way in nature. That is, in addition to transmitting instructions to the device—the smart phone also receives and displays information as to the conditions inside of the device. For example, as described above, where an alert is triggered on the GUI 40 indicating a presence of active ingredient—that will be difficult to be observed by a user holding the unit to his her/mouth. However, if the device (“unit” and “device” used interchangeably herein to refer to the vaporizer) is connected to a smart phone, the smart phone may be placed on the table in constant line of sight of a use. Other conditions of the device that may be displayed on a smartphone include the temperature of the device, any settings (e.g. high, low . . . ) and how many “draws” a user has taken.

It will be understood by those of ordinary skill in the art that in addition to using a smart phone, a general purpose computer such as a laptop or desktop also may be utilized to control the vaporizer unit in a manner similar to that described above. This would include electrical devices with processing power, user interface and web capabilities of a smartphone or like computing device (desktop, laptop, tablet/slate).

Having described this invention with regard to specific embodiments, it is to be understood that the description is not meant as a limitation since further modifications and variations may be apparent or may suggest themselves to those skilled in the art. It is intended that the present application cover all such modifications and variations.

What is claimed is:

1. An apparatus for vaporizing natural substances, comprising:
a primary draw tube for drawing ambient air;
a compound vessel for holding natural substances;
a heating chamber disposed in thermal communication with said compound vessel;
a secondary air tube in fluid communication with said heating chamber said heating chamber receiving a flow of air from said secondary air tube;
said compound vessel comprising an outlet;
said outlet being in communication with a channel, said channel delivering air to said primary draw tube.

2. The apparatus of claim 1, further comprising a first thermocouple is said heating chamber and a second thermocouple in or near said outlet.

3. The apparatus of claim 2, further comprising a GUI, said GUI receiving an alert when a temperature differential between a measurement by said first thermocouple and a measurement by said second thermocouple is greater than a standard.

4. The apparatus of claim 3, further comprising a port for connecting a computer or smartphone.

5. A method of determining whether or not active ingredient is present in an air stream, comprising the steps of:
determining a first temperature differential by measuring the temperature of air in a heating chamber and measuring the temperature of air exiting a compound chamber having no compound therein;
determining a second temperature differential by measuring the temperature of air in a heating chamber and measuring the temperature of air exiting a compound chamber having compound therein;
determining if said second temperature differential is greater than said first temperature differential.

6. The method of claim 5, further comprising the step of determining whether or not said second temperature differential is greater than said first temperature differential by at least a minimum number of degrees.

7. The method of claim 6, further comprising the step of generating an alert on a GUI when said second temperature differential is greater than said first temperature differential by at least a minimum number of degrees.

8. A method of interfacing controlling a vaporizer apparatus, comprising the steps of:
connecting a smartphone either wired or wirelessly to said vaporizer apparatus;
imputing commands on said smartphone, said commands controlling functions on said vaporizer apparatus;
receiving information on said smartphone relating to conditions of said vaporizer.
